(19) United States
(12) Patent Application Publication
(10) Pub. No.: US 2010/0202496 A1
(43) Pub. Date: Aug. 12, 2010

(54) RECONFIGURABLE TRANSFORM DOMAIN RECEIVER

(75) Inventors: Sebastian Hoyos, Bryan, TX (US); Mandar S. Kulkarni, College Station, TX (US); Pradeep Kotte Prakasam, College Station, TX (US); Xi Chen, College Station, TX (US); Brian Marshall Sadler, Laurel, MD (US)

Correspondence Address: CONLEY ROSE, P.C.;David A. Rose, P. O. BOX 3267, HOUSTON, TX, 77253-3267, US

(73) Assignee: THE TEXAS A&M UNIVERSITY SYSTEM, College Station, TX (US)

(21) Appl. No.: 12/691,334

(22) Filed: Jan. 21, 2010

Related U.S. Application Data
(60) Provisional application No. 61/146,236, filed on Jan. 21, 2009.

(51) Int. Cl. H04L 27/06; H04B 1/16; H04B 1/707

(52) U.S. Cl. 375/147; 455/334; 375/340; 375/E01.002

(57) ABSTRACT

A system is provided. The system comprises a transform domain radio receiver comprising a plurality of reconfigurable processing paths coupled to a radio frequency signal input, each reconfigurable processing path implementing a down converter, a low-pass filter, and an integrator and wherein a frequency selectivity of the processing path is reconfigurable. The system also comprises a control unit to configure a frequency selectivity of the plurality of parallel reconfigurable processing paths.

### CROSS-REFERENCE TO RELATED APPLICATIONS

The present application claims the benefit under 35 U.S.C. §119(e) of U.S. Provisional Patent Application No. 61/146,236 filed Jan. 21, 2009, entitled “Reconfigurable Transform Domain Receiver,” by Sebastian Hoyos et al., the disclosure of which is hereby incorporated herein by reference.

### STATEMENT REGARDING FEDERALLY SPONSORED RESEARCH OR DEVELOPMENT

This invention was made with Government support from the Army Research Laboratory contract number 20002503. The government may have certain rights in this invention.

### REFERENCE TO A MICROFICHE APPENDIX

Not applicable.

### BACKGROUND

A variety of wireless communication standards are known. Some electronic devices desirably are implemented as multi-protocol devices able to communicate according to two or more wireless communication standards. In some cases, electronic devices may provide multi-protocol support by providing multiple independent radios. Software defined radio (SDR) research efforts provide some hope of providing multi-protocol support with a single radio, thereby reducing costs and reducing package size. Additionally, software defined radio may promote other advantages, for example reducing the number of different manufacturing assembly lines necessary for manufacturing electronic devices that support different wireless communication standards.

### SUMMARY

In an embodiment, a system is disclosed. The system comprises a transform domain radio receiver comprising a plurality of reconfigurable processing paths coupled to a radio frequency signal input, each reconfigurable processing path implementing a down converter, a low-pass filter, and an integrator and wherein a frequency selectivity of the processing path is reconfigurable. The system also comprises a control unit to configure a frequency selectivity of the plurality of parallel reconfigurable processing paths.

In an embodiment, a method is disclosed. The method comprises a first reconfigurable processing path coupled to a radio frequency input receiving a first radio frequency range, wherein the first radio frequency range is a portion of the radio frequency input and the first reconfigurable processing path outputting a first digital data stream based on the first radio frequency range, wherein the first digital data stream represents a sequence of frequency domain coefficients. The method further comprises a second reconfigurable processing path coupled to the radio frequency input receiving a second radio frequency range, wherein the second radio frequency range is a portion of the radio frequency input and the second reconfigurable processing path outputting a second digital data stream based on the second radio frequency range, wherein the second digital data stream represents a sequence of frequency domain coefficients. The method further comprises an electronic control unit reconfiguring the first reconfigurable processing path, the first reconfigurable processing path receiving a third radio frequency range, wherein the third radio frequency range is a portion of the radio frequency input and wherein the third radio frequency range is different from the first radio frequency range, and the first reconfigurable processing path outputting a third digital data stream based on the third radio frequency range, wherein the third digital data stream represents a sequence of frequency domain coefficients.

In an embodiment, a system is disclosed. The system comprises a transform domain radio receiver comprising a low noise amplifier coupled to a radio frequency input, a plurality of reconfigurable processing paths, and a control unit. Each reconfigurable processing path is coupled to the low noise amplifier and comprises a current generator coupled to the low noise amplifier, a first switch coupled to the current generator, a second switch coupled to the current generator, a first sampling switch coupled to the first switch and to a first sampling point, a second sampling switch coupled to the second switch and to a second sampling point, a first sampling capacitor coupled to the first switch and to the first sampling switch, a second sampling capacitor coupled to the second switch and to the second sampling switch, and an overlap capacitor circuit coupled to the first switch, to the first sampling switch, and to the first sampling capacitor at a first node of the overlap capacitor circuit and coupled to the second switch, to the second sampling switch, and to the second sampling capacitor at a second node of the overlap capacitor circuit, wherein the overlap capacitor circuit comprises at least one overlap path comprising a first overlap capacitor, a first overlap switch, and a second overlap switch, wherein the first overlap switch is coupled to the first node and to the first overlap capacitor, wherein the second overlap switch is coupled to the second node and to the first overlap capacitor, wherein the switches and capacitors implement a reconfigurable low-pass filter and an integrator, and wherein an output of the sampling points provide a sequence of frequency domain coefficients. The control unit configures a periodic switching of each of the first switch, the second switch, the first sampling switch, the second sampling switch, the first overlap switch, and the second overlap switch of each of the reconfigurable processing paths, whereby the frequency bandwidth processed by each reconfigurable processing path is configured, at least in part.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a transform domain receiver according to an embodiment of the disclosure.

FIG. 2 is a block diagram of a path of a transform domain receiver according to an embodiment of the disclosure.

FIG. 3 is an illustration of a portion of a path of a transform domain receiver according to an embodiment of the disclosure.

FIG. 4 is a waveform diagram according to an embodiment of the disclosure.

FIG. 5 is an illustration of an effective integration window according to an embodiment of the disclosure.

FIG. 6 is an illustration of a portion of a path of a transform domain receiver according to an embodiment of the disclosure.

FIG. 7 is a waveform diagram according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or in existence. The disclosure should in no way be limited to the illustrative implementations, drawings, and techniques illustrated below, but may be modified within the scope of the appended claims along with their full scope of equivalents.

A front-end for a transform domain radio receiver is described herein. The disclosed front-end component may have other radio processing applications. The system parallelizes the front-end processing by expanding the received radio frequency (RF) input signal onto a set of basis functions. The expansion over a basis function is accomplished by mixing with a locally generated waveform and then integrating over a time window of length T. Each expansion may employ a parallel path, and parallel sampling at the end of the integration time provides a set of coefficients that become the digital representation of the signal. In an embodiment, the coefficients may be considered to be similar to Fourier series coefficients of a signal. Alternatively, in another embodiment, the coefficients may be considered to represent coefficients of a different set of orthogonal basis functions. In some contexts, these coefficients may be referred to as frequency domain coefficients. The term transform domain radio receiver alludes to the transformation of a time domain Signal—the input to the front-end of the transform domain radio receiver—to a frequency domain signal—at the output of the front-end of the transform domain radio receiver. The sequence of coefficients may be said to capture of represent the input radio frequency signal or an information content that is modulated on the input radio frequency signal.

The disclosed topology, in an embodiment, may promote the realization of a software defined radio receiver and/or a firmware defined radio receiver capable of supporting multiple wireless communication standards. example, in an embodiment, the disclosed system provides a reconfigurable front-end that interworks with both narrowband wireless communication standards such as global system for mobile communications (GSM) and Bluetooth but also wideband standards such as worldwide interoperability for microwave access (WiMAX) and very wideband standards such as ultrawideband (UWB). The reconfigurable system may promote reduced power consumption operating modes, reduced complexity, and/or a reduced area on a chip. In an embodiment, the reconfigurable transform domain receiver front end may be embedded in a mobile phone, a personal digital assistant, a media player, or in another form of portable electronic device operable to receive a radio signal.

In an embodiment, the system may be implemented in complementary metal oxide semiconductor (CMOS) technology. In another embodiment, however, the system may be implemented according to other technologies. It is contemplated that the transform domain radio receiver front-end may be implemented in 45 nm semiconductor technology, but it is also contemplated that as semiconductor fabrication art is advanced that the transform domain radio receiver front-end may be implemented in yet smaller feature size semiconductor technology. Alternatively, the transform domain radio receiver front-end may be implemented in larger feature size semiconductor technology. For additional information about converting analog signals to digital signals see U.S. Pat. No. 7,253,761 B1 issued Aug. 7, 2007, entitled “Analog to Digital Conversion with Signal Expansion,” by Sebastian Hoyos et al, which is hereby incorporated by reference.

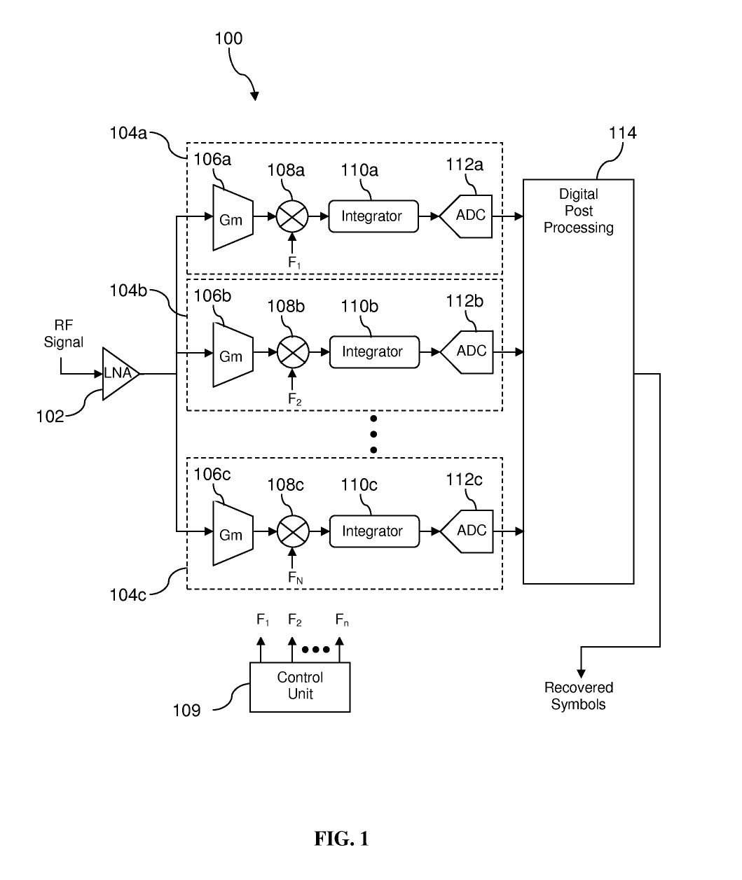

Turning now to FIG. 1, a reconfigurable transform domain radio receiver front-end system 100 is discussed. In an embodiment, the system 100 comprises a low noise amplifier (LNA) 102, and a plurality of parallel processing paths 104. In an embodiment, the system 100 provides outputs to a digital post processing component 114. In another embodiment, however, the low noise amplifier 102 may be replaced by another type of radio frequency amplifier. The system 100 receives a radio frequency input, for example from an antenna (not shown), that the low noise amplifier 102 amplifies and propagates to the parallel processing paths 104. Each of the parallel processing paths 104 first converts the voltage signal propagated by the low noise amplifier 102 to a corresponding current signal in a current generator 106. The current signal is down converted from a radio frequency current signal to an intermediate frequency (IF) or a baseband frequency by a mixer 108, where the down conversion of each mixer 108 is controlled by a basis signal Fᵢ input to the subject mixer 108.

The basis signals may be provided by a sinusoidal signal or by a square wave of the appropriate frequency. In an embodiment, the basis signals may be provided to the parallel processing paths 104 and/or controlled by a control unit 109. The down converted current signal is integrated by an integrator 110 over a limited time duration T. The integration of the signal over the time T may be referred to in some contexts as integrating in or over a time window. The integrated signal is sampled and digitized by an analog-to-digital converter (ADC) 112. For example the analog-to-digital converter 112 may periodically sample and digitize the integrated signal. The output of the analog-to-digital converter 112 represents the coefficient of the basis function F. By repeatedly processing the radio frequency input, a series of coefficients sets are generated that represent the radio frequency input. The series of coefficients may be said to be a frequency domain representation or a transform domain representation of the radio frequency input.

When a narrowband radio frequency input is processed, one or a small number of the parallel processing paths 104 may be used to process the narrowband input while the remaining parallel processing paths 104 are turned off, for example powered down. When a very wideband radio frequency input is processed, all of the parallel processing paths 104 may be used to process the very wideband input. The number of parallel processing paths 104 that are used in an operating mode of the system 100 may be controlled by software and/or firmware executing on a processor (not shown) associated with the electronic device within which the system 100 is embedded. The processor may be implemented as one or more of a microprocessor, a microcontroller, a digital signal processor (DSP), an application specific integrated circuit (ASIC), a field programmable gate array (FPGA), or other logic device. In an embodiment, for example, the system 100 may form a radio front-end of a radio receiver of a mobile communication device, for example a mobile telephone. The mobile communication device may include an antenna, the radio front-end, other receiver components, a central processor, and a memory containing one or more communications firmware applications, software applications, and/or computer programs. When executed on the central processor, the communications software applications may dynamically reconfigure the system 100, for example by turning on or turning off selected parallel processing paths 104. The central processor may communicate with the control unit 109 to command the control unit to configure the parallel processing paths, for example by configuring the waveforms Fᵢ provided to the parallel processing paths 104. Alternatively, the central processor may fulfill the role ascribed to the control unit 109 above and provide the appropriate waveforms Fᵢ to the parallel processing paths 104. In an embodiment, the radio receiver including the system 100 may be integrated with logic on a single semiconductor chip.

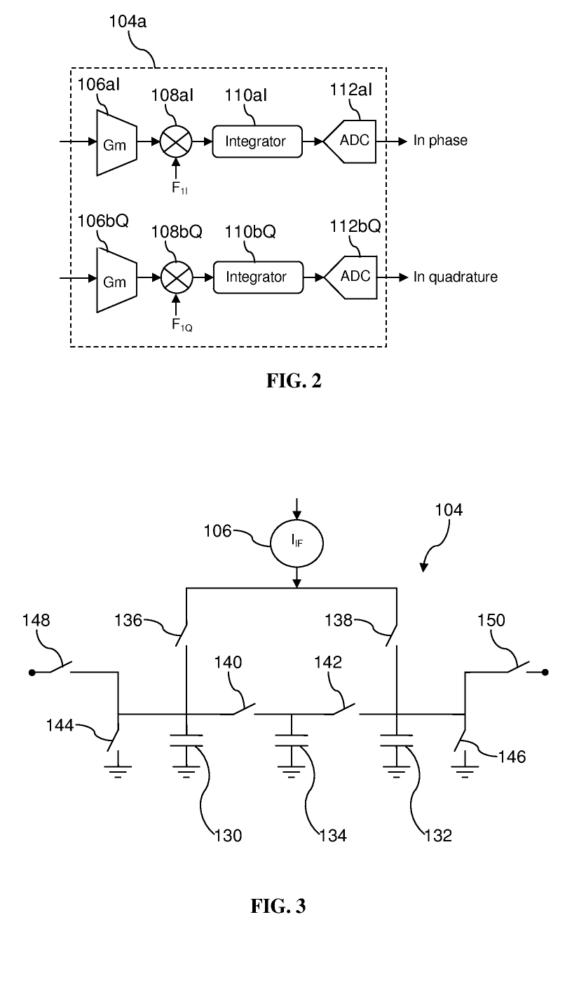

Turning now to FIG. 2, a parallel processing path 104 is described in more detail. The parallel processing paths 104 may each comprise an in-phase processing path and a quadrature processing path. As is known to those of ordinary skill in the art, communications signals are sometimes generated as an in-phase component at a given frequency and as a quadrature component at the same frequency shifted plus or minus 90 degrees in phase with respect to the in-phase component. A first parallel processing path 104a may comprise a first in-phase current generator 106aI, a first in-phase mixer 108aI, a first in-phase integrator 110aI, and a first in-phase analog-to-digital converter 112aI. The first parallel processing path 104a may further comprise a first quadrature current generator 106aQ, a first quadrature mixer 108aQ, a first quadrature integrator 110aQ, and a first quadrature analog-to-digital converter 112aQ. In an embodiment, the first in-phase mixer 108aI is controlled by a basis signal F_{1I} and the first quadrature mixer 108aQ is controlled by a basis signal F_{1Q}, wherein the basis signal F_{1Q} has the same frequency as the basis signal F_{1I}, and wherein the F_{1Q} is shifted about plus or minus 90 degrees in phase relative to F_{1I}. It is understood that the first parallel processing path 104a may include a low-pass filtering function provided between the first in-phase mixer 108aI and the first in-phase integrator 110aI and a low-pass filtering function provided between the first quadrature mixer 108aQ and the first quadrature integrator 110aQ to select an appropriate frequency band of the radio frequency input for processing.

The parallel processing paths 104 described above represented functional processing steps as processing blocks which may be implemented in circuitry in a variety of specific designs. Turning now to FIG. 3, an implementation of a portion of the parallel processing path 104 is described. In an embodiment, the down conversion function, the low-pass filtering function, and the integrating function of the parallel processing path 104 are provided by an arrangement of switches and capacitors. These functions, in an embodiment, may be provided by a first sampling capacitor 130, a second sampling capacitor 132, an overlap capacitor 134, a first switch 136, a second switch 138, a third switch 140, a fourth switch 142, a first reset switch 144, a second reset switch 146, a first sampling switch 148, and a second sampling switch 150. It is understood that, in an embodiment, switches may be implemented as circuit elements, such as transistors, that are turned on or turned off electrically. In an embodiment, the circuit shown in FIG. 3 may be implemented with additional switches and/or capacitors to achieve alternative filtering functionality suitable to the parallel processing paths 104 of the reconfigurable transform domain receiver system 100.

By reconfiguring the control inputs that control the switches 136-150, one or more of the down conversion function, the low-pass filtering function, and the integrating function of the parallel processing path 104 may be reconfigured. For example, the low-pass filtering function can be reconfigured to implement a different filtering function by reconfiguring the control inputs. Likewise, the down conversion frequency parameters can be reconfigured by reconfiguring the control inputs. In some contexts, the down conversion functionality may be referred to as a reconfigurable down converter; the low-pass filter may be referred to as a reconfigurable low-pass filter; and the integrator may be referred to as a reconfigurable integrator, wherein the reconfiguring is accomplished by reconfiguring the control inputs as discussed more fully below.

In an embodiment, when the first switch 136 is closed, when the third switch 140 is closed, and the first reset switch 144 is open, the first sampling capacitor 130 and the overlap capacitor 134 are charged with current supplied by the current generator 106. When the first switch 136 is closed, when the third switch 140 is open, and the first reset switch 144 is open, the first sampling capacitor 130 is charged with current supplied by the current generator 106. When the first reset switch 144 is closed, the first sampling capacitor 130 discharges to ground. When the third switch 140 is closed and the first reset switch 144 is closed, the overlap capacitor 134 discharges to ground. When the second switch 138 is closed, the fourth switch 142 is closed, and the second reset switch 146 is open, the second sampling capacitor 132 and the overlap capacitor 134 are charged with current supplied by the current generator 106. When the second switch 138 is closed, the fourth switch 142 is open, and the second reset switch 146 is open, the second sampling capacitor 132 is charged with current supplied by the current generator 106. When the second reset switch 146 is closed, the second sampling capacitor 132 discharges to ground. When the second reset switch 146 is closed and the fourth switch 142 is closed, the overlap capacitor 134 discharges to ground. When the first sampling switch 148 is closed, the voltage is sampled from the first sampling capacitor 130 and optionally the overlap capacitor 134. When the second sampling switch 150 is closed, the voltage is sampled from the second sampling capacitor 132 and optionally the overlap capacitor 134.

By controlling the state of the switches, the circuit illustrated in FIG. 3 may perform down conversion, low-pass filtering, and integration functions. The novel structure of the reconfigurable transform domain receiver front-end 100 and the parallel processing path 104 of FIG. 3 is an efficient design that may reduce the footprint of a radio receiver and/or radio transceiver on a semiconductor chip. In an embodiment, the control unit 109 and/or software executing on a processor may control the switches, for example by controlling a clock signal generation circuit that outputs control signals, for example the waveforms Fᵢ, to the switches or otherwise. The low-pass filtering, in combination with down conversion, promotes the parallel processing path 104 processing only a portion of the signal bandwidth of the radio frequency signal output by the low noise amplifier 102, and in an embodiment processing only a portion of the signal bandwidth of the radio frequency signal may permit relaxing the tracking bandwidth constraints of the analog-to-digital converters 112 and reducing the power consumption of each of the parallel processing paths 104. It will be readily appreciated by those of ordinary skill in the art that the charging of the capacitors 130, 132, 134 provides an integrating function.

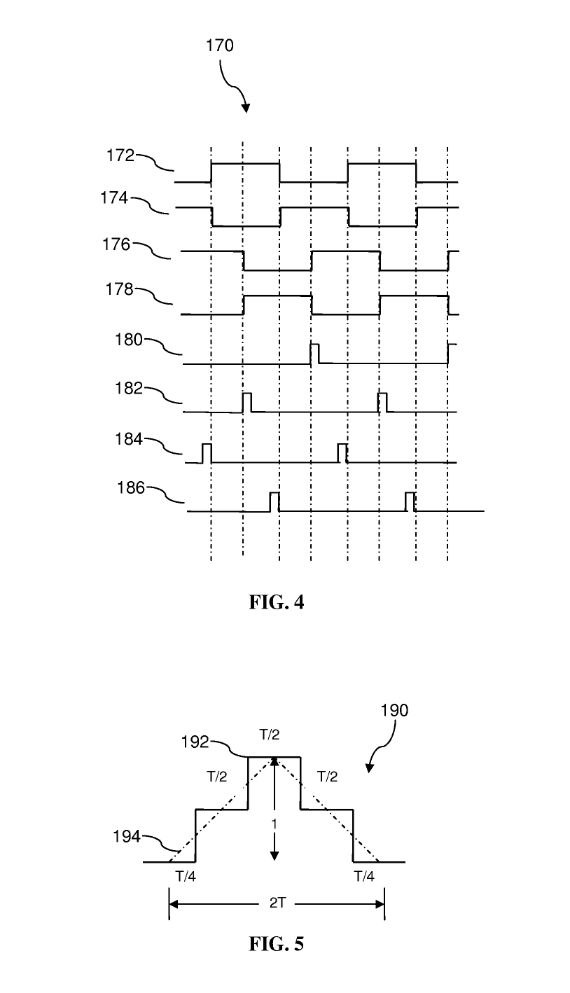

Turning now to FIG. 4, a periodic switch control sequence 170 is illustrated. A first control sequence 172 controls the first switch 136. A second control sequence 174 controls the second switch 138. A third control sequence 176 controls the third switch 140. A fourth control sequence 178 controls the fourth switch 142. A fifth control sequence 180 controls the first sampling switch 148. A sixth control sequence 182 controls the second sampling switch 150. A seventh control sequence 184 controls the first reset switch 144. An eighth control sequence controls the second reset switch 146. It is understood that, until the periodic switch control sequence 170 is reconfigured, for example to configure a different filter function, a different pass band, or another path processing function, each of the control sequences 172-186 repeat periodically. A high on the control sequence 172, 174, 176, 178, 180, 182, 184, 186 represents a closed switch while a low represents an open switch. The timing of the switch control sequence 170 conforms appropriately with the frequency of the basis function F described above with reference to the mixer 108. It is understood that the switch control sequence 170 may have any periodic frequency, but as one example, the period of the switch control sequence 170 may be about 8 nanoseconds and the corresponding periodic frequency may be about 125 MHz.

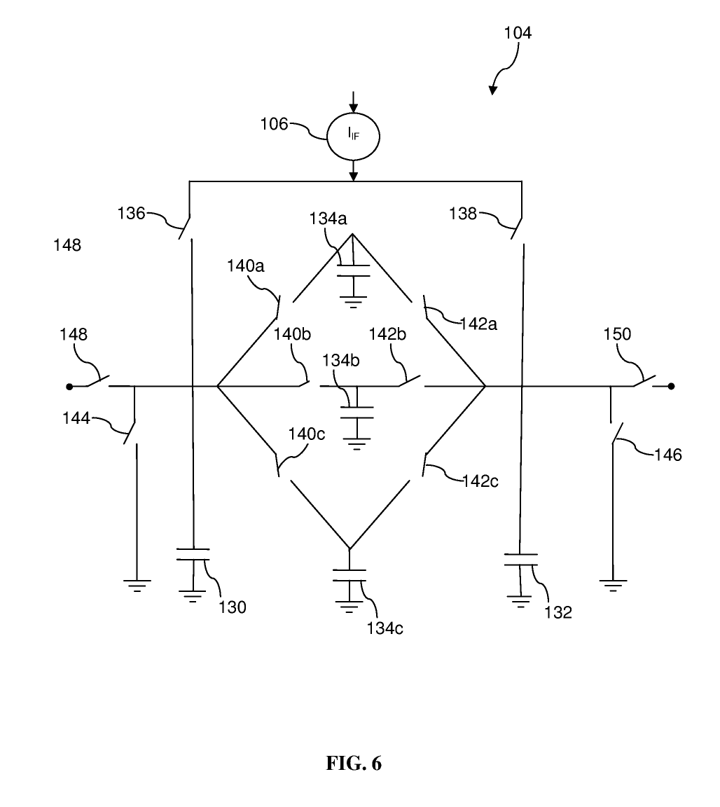

The circuit illustrated in FIG. 3 implements, in part, an approximation of a triangle function which corresponds to a sinc² filter when the switches 136 through 150 are controlled in accordance with the switch control sequence 170. This is illustrated in FIG. 5, where T is ½ the period of the switch control sequence 170. In an embodiment, the integration window 190 associated with the circuit illustrated in FIG. 3 is represented by the stepwise approximation 192 of a triangular window 194. The filter implemented by the circuit illustrated in FIG. 3 may be referred to as a finite impulse response (FIR) type of filter. The filter implemented by the circuit illustrated in FIG. 3 also may be referred to as a window type of filter, and the sampling by the analog-to-digital converters 112 may be referred to as windowed integration sampling. The implementation of the portion of the parallel processing path 104 illustrated in FIG. 3 may be referred to as a passive circuit or as implemented based on a passive integrator. In an alternative implementation, the portion of the parallel processing path 104 may be implemented as an active circuit, for example implemented based on an active integrator incorporating a high gain amplifier to attenuate the effects of parasitic capacitance resulting from parasitic diodes, overlaps, crossings, strays, and fringing effects of practical, real-world circuit elements. In an embodiment, the active integrator may be implemented by connecting a first amplifier across the first sampling capacitor 130 and connecting a second amplifier across the second sampling capacitor 132. In another embodiment, the active integrator may be implemented by coupling one or more amplifiers into the circuit according to a different topology.

By altering the timing of the switch control sequence 170, different down conversions associated with different basis functions F may be performed. Additionally, by altering the relationships among the control sequences 172, 174, 176, 178, 180, 182, 184, 186 from those illustrated in FIG. 4, different filter functions may be provided by the circuit illustrated in FIG. 3. Different finite impulse response type filters may be implemented by reconfiguring the parallel processing paths 104. Different window type filters may be implemented by reconfiguring the parallel processing paths 104. The control unit 109, a computer program executing on a processor, or another control circuit element may change the switch control sequences 170 provided to each of the parallel processing paths 104 to implement different down conversion, filtering, and integration functions, thereby reconfiguring the system 100. By this action, one or more parallel processing paths 104 may be turned on and/or turned off. By this action, the frequency ranges processed by each of the active parallel processing paths 104 may be configured and/or reconfigured. By this action, a filter implemented by the parallel processing path 104 may be reconfigured, for example to provide a longer filtering window, to achieve a sharper frequency cut-off, to change the pass band of the filter.

At the end of a sampling interval, the analog-to-digital converter 112 samples the voltage stored on the first sampling capacitor 130 and optionally the overlap capacitor 134 via the first sampling switch 148 controlled by waveform 180 and samples the voltage stored on the second sampling capacitor 132 and optionally the overlap capacitor 134 via the second sampling switch 150 controlled by waveform 182. After sampling, the first reset switch 144 may be closed by the waveform 184 to discharge and reset the first sampling capacitor 130 and optionally the overlap capacitor 134. Likewise, after sampling, the second reset switch 146 may be closed by the waveform 186 to discharge and reset the second sampling capacitor 132 and optionally the overlap capacitor 134. In an embodiment, the process of discharging of the capacitors 130, 132, and 134 may prevent the propagation of unwanted noise and/or distortion into later samplings of the basis function coefficients. In an embodiment, the pulse width of the sampling and reset pulses of the waveforms 180, 182, 184, and 186 may have different time durations than those represented in FIG. 4. The width of the pulses of waveforms 180 and 182 may be determined so that they are effective for sampling voltages, and the width of the pulses of waveforms 184 and 184 may be determined so that they are effective for resetting capacitors.

Turning now to FIG. 6, an alternative implementation of a portion of the parallel processing path 104 is described. The circuit of FIG. 6 is similar in structure to the circuit of FIG. 3, with the exception that in FIG. 3 there was a single overlap capacitor leg while in FIG. 6 there are three overlap capacitor legs. The circuit of FIG. 6 implements a sinc²↓4 four times down-sampling filter. By building the circuit of FIG. 6 with two overlap capacitor legs, a sinc² ↓2 two times down-sampling filter may be implemented. By building the circuit of FIG. 6 with more overlap capacitor legs, a sinc² ↓N N times down-sampling filter may be implemented. By controlling the overlap capacitors with control waveforms, a sinc² ↓N N times down-sampling filter can be reconfigured to implement a sinc² filter with a lower order of down-sampling, simply by disabling one or mole overlap capacitor legs of the circuit. As with the circuit of FIG. 3 described above, in an embodiment, the implementation of FIG. 6 may be implemented either as a passive circuit, as illustrated, or as an active circuit incorporating two or more high gain amplifiers.

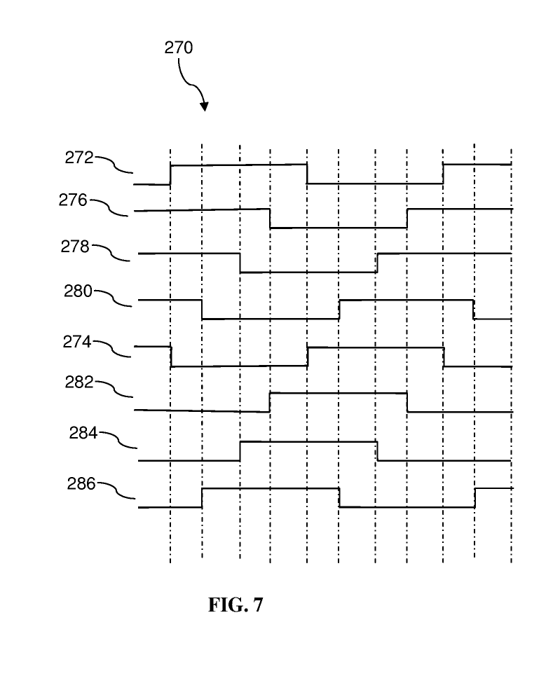

Turning now to FIG. 7 a periodic switch control sequence 270 is illustrated. A ninth control sequence 272 controls the first switch 136. A tenth control sequence 274 controls the second switch 138. An eleventh control sequence 276 controls the overlap switch 140a. A twelfth control sequence 278 controls the overlap switch 140b. A thirteenth control sequence 280 controls the overlap switch 140c. A fourteenth control sequence 282 controls the overlap switch 142a. A fifteenth control sequence 284 controls the overlap switch 142b. A sixteenth control sequence 286 controls the overlap switch 142c. It is understood that, until the periodic switch control sequence 270 is reconfigured, for example to configure a different filter function, a different pass band, or another path processing function, each of the control sequences 272-286 repeat periodically.

The disclosed architecture and systems may provide a convenient trade-off between complexity and speed. Different speeds and dynamic ranges may be achieved by varying the number of parallel paths used for signal expansion and quantization. For example, reconfiguring the system 100 to use more parallel processing paths 104 to process a given signal may be associated with different speeds and dynamic range and/or resolution. For example, using more parallel processing paths 104 may permit a correspondingly slower sampling speed. Alternatively, using more parallel processing paths 104 while using the same sampling speed may provide greater conversion resolution. This flexibility may find applications in software defined radio multi-standard receivers and/or in other radio receiver and/or signal processing applications. For example, the reconfigurable transform domain radio receiver system 100 may promote manufacturing a phone which can be used throughout the world, automatically reconfiguring the parallel processing paths 104 to adapt to different spectrum allocations in different countries and or wireless networks. The reconfigurable transform domain radio receiver system 100 may promote building an inexpensive generic radio transceiver that can be assembled into all phones on an assembly line, independently of target marketplace, thereby reducing parts counts and inventory complexity. In this example, the specific spectrum allocation of the different market places could be accommodated by configuring the parallel processing paths 104 of the reconfigurable transform domain radio receiver system 100 when provisioning the mobile phone or at some other point before handing over the phone to the customer.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A system, comprising:
a transform domain radio receiver comprising
a plurality of reconfigurable processing paths coupled to a radio frequency signal input, each reconfigurable processing path implementing a down converter, a low-pass filter, and an integrator and wherein a frequency selectivity of the processing path is reconfigurable; and
a control unit to configure a frequency selectivity of the plurality of parallel reconfigurable processing paths.

2. The system of claim 1, wherein the transform domain radio receiver further comprises a digital post processing component that receives the output of each of the reconfigurable processing paths to recover symbols encoded in the radio frequency signal input.

3. The system of claim 1, wherein the reconfigurable processing paths output a sequence of frequency domain coefficients based on the radio frequency signal input.

4. The system of claim 1, wherein each reconfigurable processing path comprises a current generator coupled to a first capacitor, a second capacitor, and a first overlap capacitor by a plurality of switches whose periodic switching pattern is configured by the control unit to determine the frequency selectivity of the reconfigurable processing path.

5. The system of claim 4, wherein the first capacitor, the second capacitor, the first overlap capacitor, and the plurality of switches form at least part of a sinc² finite impulse response filter.

6. The system of claim 4, wherein each reconfigurable processing path implements an active integrator.

7. The system of claim 4, further comprising a second overlap capacitor, and wherein the first capacitor, the second capacitor, the first overlap capacitor, the second overlap capacitor, and the plurality of switches form at least part of a sinc² ↓2 two times down-sampling finite impulse response filter.

8. The system of claim 4, further comprising a plurality of additional overlap capacitors, and wherein the first capacitor, the second capacitor, the overlap capacitors, the second overlap capacitor, and the plurality of switches are configurable by the control unit to implement one of a sinc² finite impulse response filter and one or more different sinc² down-sampling finite impulse response filters.

9. A method, comprising:
a first reconfigurable processing path coupled to a radio frequency input receiving a first radio frequency range, wherein the first radio frequency range is a portion of the radio frequency input;
the first reconfigurable processing path outputting a first digital data stream based on the first radio frequency range, wherein the first digital data stream represents a sequence of frequency domain coefficients;
a second reconfigurable processing path coupled to the radio frequency input receiving a second radio frequency range, wherein the second radio frequency range is a portion of the radio frequency input;
the second reconfigurable processing path outputting a second digital data stream based on the second radio frequency range, wherein the second digital data stream represents a sequence of frequency domain coefficients;
an electronic control unit reconfiguring the first reconfigurable processing path;
the first reconfigurable processing path receiving a third radio frequency range, wherein the third radio frequency range is a portion of the radio frequency input and wherein the third radio frequency range is different from the first radio frequency range; and
the first reconfigurable processing path outputting a third digital data stream based on the third radio frequency range, wherein the third digital data stream represents a sequence of frequency domain coefficients.

10. The method of claim 9, wherein the first and second reconfigurable processing path and the electronic control unit are components of a reconfigurable transform domain radio transceiver.

11. The method of claim 9, wherein receiving the radio frequency range that is a portion of the radio frequency input comprises down converting and low-pass filtering the radio frequency input to select the subject radio frequency range and integrating the radio frequency range over sampling time intervals.

12. The method of claim 11, wherein the first reconfigurable processing path implements a sinc² down-sampling finite impulse response window-type filter in a first configuration and wherein the first reconfigurable processing path implements a sinc² finite impulse response window-type filter without down-sampling in a second configuration based on the electronic control unit reconfiguring the first reconfigurable processing path.

13. The method of claim 11, wherein the low-pass filtering is accomplished with a sinc²-type filtering.

14. The method of claim 11, wherein the low-pass filtering is accomplished with a finite impulse response window-type filter.

15. A system, comprising:
a transform domain radio receiver comprising
a low noise amplifier coupled to a radio frequency input;
a plurality of reconfigurable processing paths, each reconfigurable processing path coupled to the low noise amplifier and comprising a current generator coupled to the low noise amplifier, a first switch coupled to the current generator, a second switch coupled to the current generator, a first sampling switch coupled to the first switch and to a first sampling point, a second sampling switch coupled to the second switch and to a second sampling point, a first sampling capacitor coupled to the first switch and to the first sampling switch, a second sampling capacitor coupled to the second switch and to the second sampling switch, and an overlap capacitor circuit coupled to the first switch, to the first sampling switch, and to the first sampling capacitor at a first node of the overlap capacitor circuit and coupled to the second switch, to the second sampling switch, and to the second sampling capacitor at a second node of the overlap capacitor circuit, wherein the overlap capacitor circuit comprises at least one overlap path comprising a first overlap capacitor, a first overlap switch, and a second overlap switch, wherein the first overlap switch is coupled to the first node and to the first overlap capacitor, wherein the second overlap switch is coupled to the second node and to the first overlap capacitor, wherein the switches and capacitors implement a reconfigurable low-pass filter and an integrator, and wherein an output of the sampling points provide a sequence of frequency domain coefficients; and
a control unit to configure a periodic switching of each of the first switch, the second switch, the first sampling switch, the second sampling switch, the first overlap switch, and the second overlap switch of each of the reconfigurable processing paths, whereby the frequency bandwidth processed by each reconfigurable processing path is configured, at least in part.

16. The system of claim 15, wherein, when configured by the control unit in a first configuration, the transform domain radio receiver receives an ultra wide band (UWB) radio frequency signal and, when configured by the control unit in a second configuration, the transform domain radio receiver receives a global system for mobile telecommunications (GSM) radio frequency signal.

17. The system of claim 15, wherein the reconfigurable processing path defines a sinc² type of filter.

18. The system of claim 15, wherein the reconfigurable processing path defines a finite impulse response window-type filter.

19. The system of claim 15, wherein the transform domain radio receiver forms part of a software defined radio.

20. The system of claim 15, wherein the transform domain radio receiver is embedded in a mobile phone.
